(19) United States
(12) Patent Application Publication
(10) Pub. No.: US 2004/0222967 A1
(43) Pub. Date: Nov. 11, 2004

(54) System and method for controlling polling of a signal in a hand-held computing device

(76) Inventors: Roy J. Riccomini, Saratoga, CA (US); Allen Lee, Los Altos, CA (US); Timothy D. Twerdahl, Los Altos, CA (US)

Correspondence Address: CARR & FERRELL LLP, 2200 GENG ROAD, PALO ALTO, CA, 94303, US

(21) Appl. No.: 10/839,925

(22) Filed: May 5, 2004

Related U.S. Application Data
(60) Provisional application No. 60/468,447, filed on May 5, 2003.

(51) Int. Cl. H04B 15/00

(52) U.S. Cl. 345/161

(57) ABSTRACT

A system and method are described for selectively controlling polling of a signal representing displacement information of an analog input device included in a hand-held computing device. In one embodiment, the analog input device generates a signal representing a displacement of the input device. A switch directs the signal to a threshold detector system, which determines whether the signal exceeds a predetermined threshold. If the threshold is exceeded, the threshold detector system generates an interrupt. The switch then directs the signal to a processor that is configured to receive a digitized version of the signal and to poll the digitized signal at a higher specified frequency.

### CROSS-REFERENCE TO RELATED APPLICATIONS

This application claims the benefit of Provisional Patent Application Ser. No. 60/468,447, filed May 5, 2003, entitled “System and Method for Generating an Analog Signal in a Hand-Held Computing Device”, which is incorporated by reference. This application is also related to U.S. patent application Ser. No. ______, entitled “System and Method for Generating an Analog Signal in a Hand-Held Computing Device”, filed May 5, 2004, which is incorporated herein by reference.

### BACKGROUND OF THE INVENTION

1. Field of the Invention

This invention relates generally to hand-held computing devices and more specifically relates to a system and method for selectively controlling polling of a signal representing displacement information of an analog input device included in a hand-held computing device.

2. Description of the Background Art

Hand-held computing devices traditionally run software applications that accept input from digital input devices (i.e., input devices having two states such as “open” or “closed” or “on” or “off”). For example, users typically navigate between and within applications running on hand-held personal digital assistants (PDAs), such as basic record keeping and scheduling software (e.g., address books, phone lists, calendars, memo lists, etc.), by engaging two-state switches (e.g., buttons) representative of up/down or left/right directions. Other types of hand-held computing devices use more sophisticated digital input devices for data input or for controlling the position of various graphics or a cursor on the display screen. Examples of these digital input devices include four-way and eight-way switches.

Recently, hand-held computing devices have been designed to run more graphics-intensive software applications, such as game applications. In such applications, it is desirable to enable users to input information, such as position information, more precisely and at a higher rate than is achievable using simple, two-state digital input devices. Typically, desktop and other stationary computing systems provide precise, high-speed control by way of an analog input device, such as a joystick. An analog input device is capable of generating signals having values within a continuous range that typically represents displacement in two orthogonal directions. With an analog input device, for example, a user can input position information in a theoretically infinite number of directions, can control an amount that the position changes in a particular direction, and can control a rate that the position changes in a particular direction. In sum, analog input devices generally are more versatile than digital input devices, and therefore enhance the performance of hand-held computing devices that run video games and other similar software.

However, using analog input devices in hand-held devices has been historically disfavored largely because such input devices require far more processing power and overhead than digital input devices. First, the analog input device typically transmits a greater amount of information to a processor than a digital input device because a sampling rate of an analog-to-digital converter (“A/D converter”) that digitizes a signal transmitted by the analog input device is higher than a rate at which a user can input information to the processor using a digital input device. Second, the processor must perform frequent computations on the digitized signal to determine corresponding position information being conveyed by movements of the analog input device. As a result, more processor resources are needed to process the information generated by the analog input device, leaving less processor bandwidth for other processing functions, such as running software applications on the hand-held device and generating graphics for those applications. This demand for available processor resources, among other things, can degrade performance in the hand-held computing device. Another challenge is that the increased processor resources required by the analog input device necessitate a greater amount of battery power, an already overly-taxed resource in hand-held devices.

### SUMMARY OF THE INVENTION

The present invention provides a system and method for selectively controlling polling of a signal representing displacement information of an analog input device included in a hand-held computing device. One embodiment of the system includes an analog input device system to generate a signal in response to movement of the analog input device, a threshold detector to generate an interrupt if the signal exceeds a predetermined threshold, and a switch to direct the signal to the threshold detector in a first state and to an A/D converter in a second state. The A/D converter digitizes the signal and transmits the signal to a processor, which polls the digitized signal for purposes of computing displacement information. The processor determines, while polling the signal, whether the signal has indicated zero displacement for a predetermined amount of time, and returns the switch to the first state upon such determination.

One embodiment of the method for selectively controlling the polling of a signal representing displacement information in a hand-held computing device includes the steps of directing the signal to a threshold detector system, determining whether the signal exceeds a predetermined threshold, generating an interrupt if the signal exceeds the predetermined threshold, directing a digitized signal corresponding to the signal to a processor in response to the interrupt, and polling the digitized signal at a specified frequency to compute displacement information.

One advantage of this system is that the processor polls the digitized signal only after the signal exceeds the predetermined threshold. Otherwise, the processor does not poll the signal at all. The result is that fewer processor resources are needed to process the displacement information captured by the signal, leaving more processor bandwidth for other processing functions. This increase in available processor resources, among other things, increases performance in hand-held computing devices. Further, with the system described above, the processor uses less battery power as the processor avoids having to poll the signal continually.

### BRIEF DESCRIPTION OF THE DRAWINGS

FIG. 1 is a top plan view illustrating one embodiment of a hand-held computing device, according to the present invention;

FIG. 2 is a partial cross-sectional view illustrating one embodiment of the analog input device of FIG. 1, according to the present invention;

FIG. 3 is a functional block diagram illustrating one embodiment of the hand-held computing device of FIG. 1;

FIG. 4 is a block diagram illustrating one embodiment of a system used to control polling of a signal representing displacement information of an analog input device included in a hand-held computing device;

FIG. 5 is a block diagram illustrating an alternative embodiment of a system used to control the polling of a signal representing displacement information of an analog input device included in a hand-held computing device;

FIG. 6 shows a flowchart of method steps for controlling the polling of a signal representing displacement information of an analog input device included in a hand-held computing device;

FIG. 7 shows a flowchart of alternative method steps for controlling the polling of a signal representing displacement information of an analog input device included in a hand-held computing device; and

FIG. 8 is an isometric illustration of the hand-held computing device of FIG. 1 showing one embodiment of a set of input devices disposed at a mid-frame of the housing.

### DETAILED DESCRIPTION OF THE INVENTION

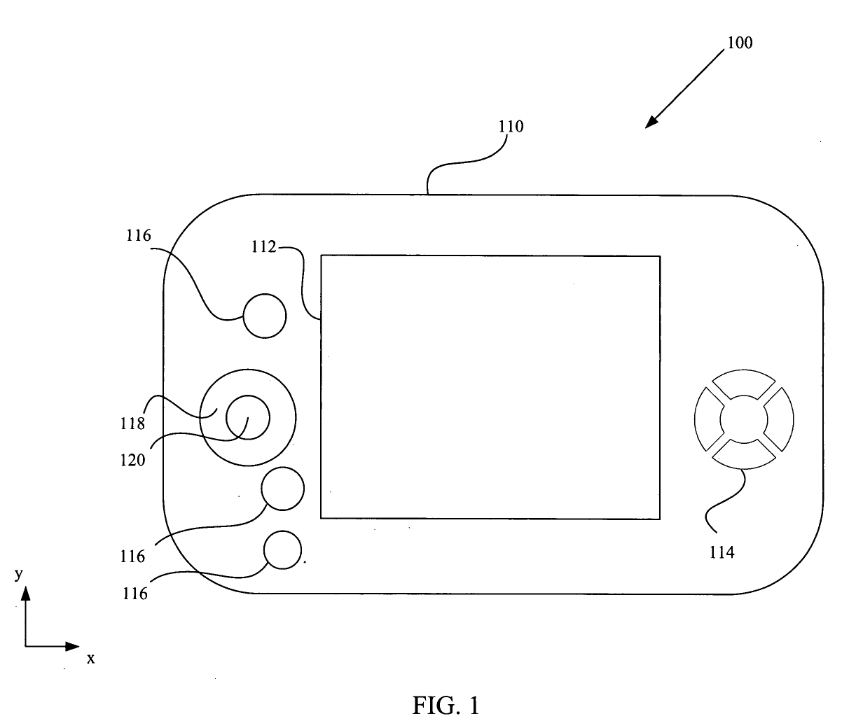

FIG. 1 is a top plan view illustrating one embodiment of a hand-held computing device 100, according to the present invention. As shown, the hand-held computing device 100 may include, without limitation, a housing 110, a display 112, a four-way digital input device 114, one or more digital input devices 116 and an analog input device 120. The housing 110 can be made of any type of suitable material such as plastic, metal, or hard rubber, and is sized such that a user can comfortably hold the hand-held computing device 100 during operation.

The four-way digital input device 114 allows the user to input various types of information into the hand-held computing device 100 by pressing any of four buttons associated with the four-way digital input device 114. In particular, the four-way digital input device 114 is conducive for inputting direction-oriented information into the hand-held computing device 100. For example, depending on the software application running on the hand-held computing device 100, the user can move a cursor or other graphics object in any one of four directions (i.e., up, down, left, or right) within the display 112 by pressing the button corresponding to that desired direction. Similarly, the user can use the four-way digital input device 114 to scroll up and down a given display screen by pressing on the top and bottom buttons, respectively.

The user also can input various types of information into the hand-held computing device 100 by pressing on any one of the digital input devices 116. For example, depending on the software application running on the hand-held computing device 100, the user can select a particular graphics object by pressing one of the digital input devices 116 once a cursor highlights that graphics object. Similarly, while playing a video game, the user can press one or more of the digital input devices 116 to fire a gun, pick up or select objects within the game, or to make a user's gaming character perform some function like kicking or punching.

The analog input device 120 allows the user to input information into the hand-held computing device 100 simply by exerting force which results in displacement of the analog input device 120 in a specific direction. The analog input device 120 is particularly useful when the user is playing a video game on the hand-held computing device 120. For example, a user can input position information in any desired direction using the analog input device 120, thereby allowing the user to direct movement of a character or other graphic object in any direction within the display 112. With the analog input device 120, the user is not limited to only the up, down, left, or right directions. Further, the user can control an amount that the character or other graphic object moves and/or the speed in which that character or other graphic moves within the display 112. In addition, the user can change the direction in which the character or other graphic object moves simply by exerting force on a portion of the analog input device 120 in a direction opposite to the movement of the character or other graphic.

It should be noted that FIG. 1 illustrates an exemplary embodiment of the hand-held computing device 100. Alternative embodiments may comprise more or fewer input devices (e.g., 114, 116, 120), and may arrange the input devices in a different manner on the hand-held computing device 100.

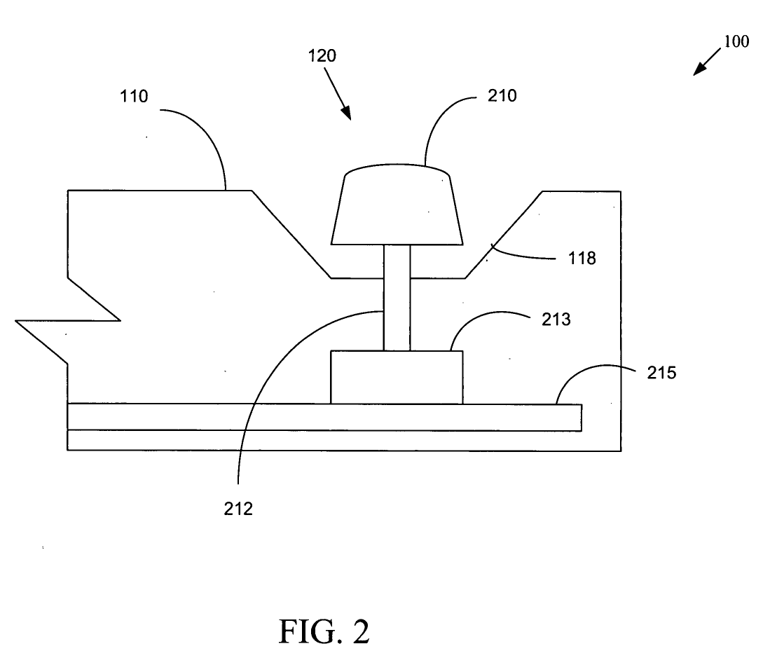

FIG. 2 illustrates a partial cross-sectional view of one embodiment of the analog input device 120 of FIG. 1, according to the present invention. The analog input device 120 is partially disposed in a well 118, which is recessed below a surface of the housing 110. Among other things, such a configuration allows the user to more easily and comfortably manipulate the analog input device 120 while holding the hand-held computing device 100. In alternative embodiments, the analog input device 120 may be located anywhere on the face of the hand-held computing device 100.

The analog input device 120 may be implemented in the form of a joystick having a cap 210 that is attached to or formed integrally with a proximal end of a shaft 212. The shaft 212 is pivotally secured to a base 213 at an opposite end. The base 213 is oriented within the hand-held computing device 100 such that displacement of the shaft 212 produces a corresponding analog signal in circuitry (not shown) residing within the hand-held computing device 100. The shaft 212 may be mechanically biased (e.g., by springs or similar expedient) to return to a baseline or return position in the absence of user-exerted force. The base 213 can also comprise gimballing assemblies, centering springs, and two-axis potentiometers, and can be coupled to a printed circuit board (“PCB”) 215. In an exemplary embodiment in accordance with the present invention, the analog input device 120 also incorporates a switch (not shown) that is activated by pressing down on the cap 210. In alternative embodiments, the analog input device 120 may be implemented as a trackball or a joystick of any shape and the well 118 may have any shape and/or be any size.

Those skilled in the art will recognize that the analog signal generated by the analog input device 120 may comprise two or more signals, each signal corresponding to a displacement of the analog input device 120 in a specified direction. For example, as described in further detail herein, the signal generated by the analog input device 120 may comprise x-axis and y-axis signals. Further, the x-axis and y-axis are merely illustrative, may be redefined without changing the scope of the present invention, and need not be orthogonal. It will be appreciated that an analog-to-digital converter (not shown) can convert the analog signal to a digital signal for a processor of the hand-held computing device 100.

In one embodiment, the well 118 is generally frustro-conical and opens outwardly and upwardly. Further, an upper end of the well 118 is large enough so that the user can move the analog input device 120 through its entire range of motion without the user hitting his or her thumb or finger (whichever is being used to move the analog input device 120) on the housing 110. In some embodiments, the well 118 may be angled with respect to the housing 110 so that the well 118 is deeper on one end. Alternatively, the well 118 may be shaped to provide an asymmetrical well 118 about the analog input device 120.

The analog input device 120 is preferably disposed partially in the well 118 such that the cap 210 does not protrude substantially above the surface of the housing 110. In one embodiment, the cap 210 protrudes above the surface of the housing 110 by approximately 1.8 mm. The amount by which the cap 210 protrudes above the surface of the housing 110, however, may vary and is a function of several factors, not limited to the following. A substantial amount of protrusion, for example, would make the hand-held computing device 100 less portable because a protective carrying case containing the hand-held computing device 100 would have to be larger (i.e., thicker) to accommodate the protrusion. Furthermore, increased protrusion leads to inadvertent operation of the analog input device 120 during handling or carrying by the user when the hand-held computing device 100 is not contained within a protective case. Inadvertent operation of the analog input device 120 may lead to increased usage of processor resources and battery drain. Further, the more that the cap 210 protrudes, the more susceptible the cap 210 is to snag (e.g., on pants or shirt pockets) or be hit by other objects, increasing the risk of damage to the analog input device 120. Further, increased protrusion increases an amount of force applied to the shaft 212, potentially causing breakage or damage to the analog input device 120 or particularly to the shaft 212 or the base 213.

On the other hand, less protrusion above the surface of the housing 110 may decrease the range of motion of the analog input device 120. Users generally prefer a greater range of motion, especially when playing video games, because a greater range of motion tends to make video games feel more interactive. A decreased range of motion, among other things, reduces the resolution of the analog input device 120 and adversely affects the performance of the hand-held computing device 100.

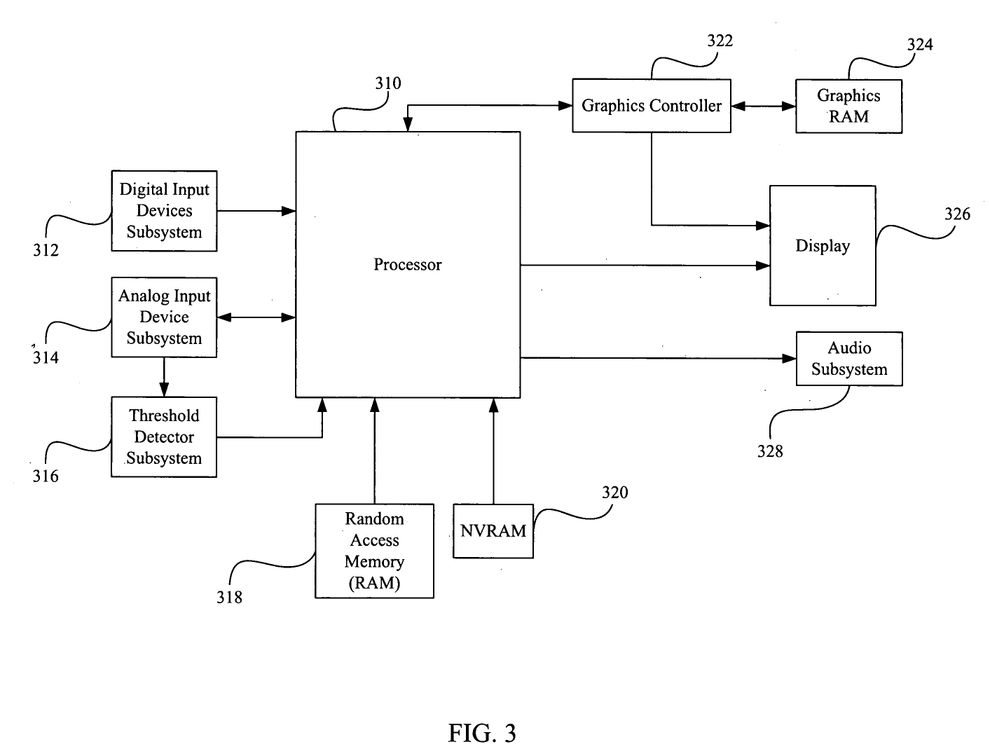

FIG. 3 is a functional block diagram illustrating one embodiment of the hand-held computing device 100 of FIG. 1, according to the present invention. As shown, the hand-held computing device 100 includes a processor 310, a digital input devices subsystem 312, an analog input device subsystem 314, a threshold detector subsystem 316, a random access memory (RAM) 318, a non-volatile random access memory (NVRAM) 320, a graphics controller 322, a graphics RAM 324, a display 326, and an audio subsystem 328. The RAM 318 and the NVRAM 320 are configured to cooperate with the processor 310 to perform various functions of the hand-held computing device 100, such as executing instructions for a particular video game or other software application running on the hand-held computing device 100. Those skilled in the art will recognize this general configuration of the hand-held computing device 100, and will understand that the hand-held computing device 100 can be configured in many other ways.

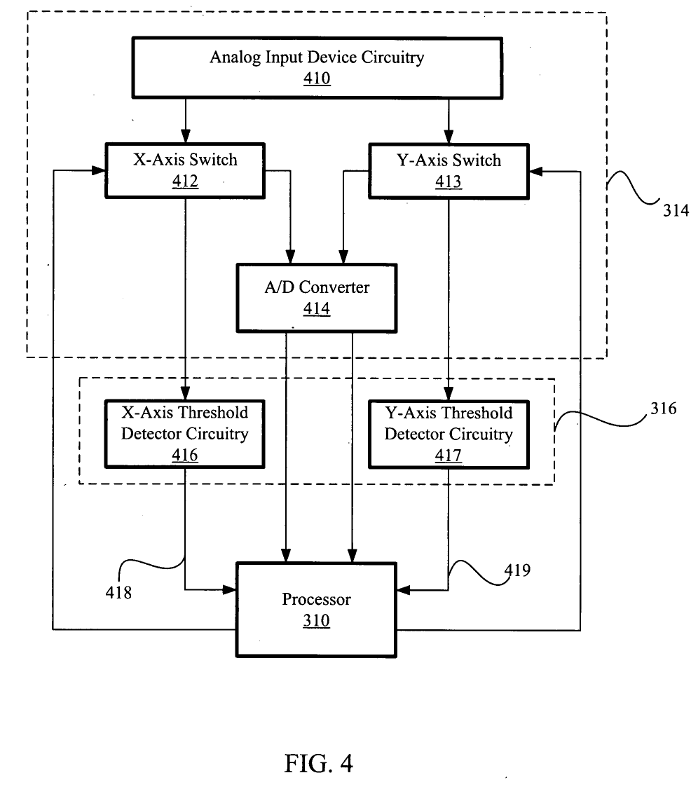

In one embodiment, the user inputs information into the hand-held computing device 100 using a combination of the four-way digital input device 114 (FIG. 1), one or more digital input devices 116 (FIG. 1), and/or the analog input device 120 (FIG. 1). The digital input devices subsystem 312 is configured to receive information from the four-way digital input device 114 and/or digital input devices 116 and to transmit that information in digital form to the processor 310. As described below in greater detail in conjunction with FIG. 4, the analog input device subsystem 314 is configured to receive information from the analog input device 120, and to either transmit that information in analog form to the threshold detector subsystem 316, or digitize that information and transmit it in digital form to the processor 310.

In exemplary embodiments, the processor 310 is configured to receive and process information from the digital input devices subsystem 312 and the analog input device subsystem 314, and to communicate with the analog input device subsystem 314 and the threshold detector subsystem 316. The processor 310 is further configured to communicate with the graphics controller 322, which in turn communicates with the graphics RAM 324, to generate graphics on the display 326. The processor 310 also communicates with the audio subsystem 328 to produce various sounds related to the software application(s) running on the processor 310.

FIG. 4 is a block diagram illustrating one embodiment of a system used to control polling of a signal representing displacement information of the analog input device 120 (FIG. 1) included in the hand-held computing device 100 (FIG. 1), according to the present invention. The system includes, but is not limited to, the analog input device subsystem 314 (FIG. 3), the threshold detector subsystem 316 (FIG. 3), and the processor 310 (FIG. 3). The analog input device subsystem 314 includes analog input device circuitry 410, an x-axis switch 412, a y-axis switch 413, and an A/D converter 414. The threshold detector subsystem 316 includes x-axis threshold detector circuitry 416 and y-axis threshold detector circuitry 417.

The analog input device circuitry 410 is configured to transmit an x-axis signal to the x-axis switch 412, and a y-axis signal to the y-axis switch 413, when the user inputs information into the hand-held computing device 100 by moving the analog input device 120 (FIG. 1) in the x-direction and the y-direction, respectively. In one embodiment, the analog input device circuitry 410 includes first and second potentiometers (not shown), in which the first potentiometer produces a first analog signal (i.e., the x-axis signal) in response to a displacement of the analog input device 120 in either the positive or negative x-direction, and the second potentiometer produces a second analog signal (i.e., the y-axis signal) in response to a displacement of the analog input device 120 in either the positive or negative y-direction. One skilled in the art will recognize that the analog input device circuitry 410 can include any type of components, electronic or otherwise, so long as the resulting circuit produces an analog signal in response to any displacement of the analog input device 120 from its x-axis or y-axis baseline or return positions.

In one embodiment, the x-axis switch 412 and the y-axis switch 413 are each two-state switches. In other embodiments, the x-axis switch 412 and the y-axis switch 413 can be multi-state switches having three or more states. The x-axis switch 412 transmits the x-axis signal to the x-axis threshold detector circuitry 416, unless the processor 310 commands the x-axis switch 412 to route the x-axis signal to the A/D converter 414 in accordance with the method described below. Similarly, the y-axis switch 413 transmits the y-axis signal to the y-axis threshold detector circuitry 417, unless the processor 310 commands the y-axis switch 413 to route the y-axis signal to the A/D converter 414.

The x-axis threshold detector circuitry 416 is configured to determine whether the x-axis signal exceeds a “predetermined x-axis threshold” corresponding to a specific amount of displacement of the analog input device 120 in the x-direction. In one embodiment, the predetermined x-axis threshold corresponds to a displacement of 30-40% of the maximum possible displacement of the analog input device 120 in the x-direction. The x-axis threshold detector circuitry 416 is further configured to generate an interrupt 418 when the x-axis threshold detector circuitry 416 determines that the x-axis signal exceeds the predetermined x-axis threshold. The interrupt 418 is transmitted to the processor 310. The processor 310 is configured such that, upon receiving the interrupt 418, the processor 310 commands the x-axis switch 412 to route the x-axis signal to the A/D converter 414 instead of the x-axis threshold circuitry 416. In alternative embodiments, as opposed to transmitting the interrupt 418 to the processor 310, the x-axis threshold detector circuitry 416 can transmit the interrupt 418 to some other component within either the analog input device subsystem 314 or the threshold detector subsystem 316, or to some other component located elsewhere within the hand-held computing device 100.

The A/D converter 414 is configured to receive the x-axis signal, to convert that signal into a corresponding digitized x-axis signal, and to transmit the digitized x-axis signal to the processor 310. The processor 310 is configured to receive the digitized x-axis signal and to poll that signal at a specified frequency for purposes of computing the displacement of the analog input device 120 (FIG. 1) in the x-direction. In one embodiment, the processor 310 polls the digitized x-axis signal at a frequency of 100 Hertz. The processor 310 is further configured to detect when the analog input device 120, returns to its x-axis baseline or return position and to measure how long the analog input device 120 remains in that position. Upon determining that the analog input device 120 has remained in its x-axis baseline or return position for a predetermined amount of time, the processor 310 commands the x-axis switch 412 to reroute the x-axis signal to the x-axis threshold detector circuitry 416. In one embodiment, this predetermined amount of time is in the range of 5-10 seconds.

Similarly, the y-axis threshold detector circuitry 417 is configured to determine whether the signal exceeds a “predetermined y-axis threshold” corresponding to a specific amount of displacement of the analog input device 120 in the y-direction. In one embodiment, the predetermined y-axis threshold corresponds to a displacement of 30-40% of the maximum possible displacement of the analog input device 120 in the y-direction. The y-axis threshold detector circuitry 417 is further configured to generate an interrupt 419 when the y-axis threshold detector circuitry 417 determines that the y-axis signal exceeds the predetermined y-axis threshold, and to transmit the interrupt 419 to the processor 310. The processor 310 is configured such that, upon receiving the interrupt 419, the processor 310 commands the y-axis switch 413 to route the y-axis signal to the A/D converter 414 instead of the y-axis threshold detector circuitry 417. In alternative embodiments, as opposed to transmitting the interrupt 419 to the processor 310, the y-axis threshold detector circuitry 417 can transmit the interrupt 419 to some other component within either the analog input device subsystem 314 or the threshold detector subsystem 316, or to some other component located elsewhere within the overall system.

The A/D converter 414 is configured to receive the y-axis signal, to convert that signal into a corresponding digitized y-axis signal and to transmit the digitized y-axis signal to the processor 310. The processor 310 is configured to receive the digitized y-axis signal and to poll that signal at a specified frequency for purposes of computing the displacement of the analog input device 120 (FIG. 1) in the y-direction. In one embodiment, the processor 310 polls the digitized y-axis signal at a frequency of 100 Hertz. The processor 310 is further configured to detect when the analog input device 120 returns to its y-axis baseline or return position and to measure how long the analog input device 120 remains in that position. Upon determining that the analog input device 120 has remained in its y-axis baseline or return position for a predetermined amount of time, the processor 310 commands the y-axis switch 413 to reroute the y-axis signal to the y-axis threshold detector circuitry 417. In one embodiment, this predetermined amount of time is in the range of 5-10 seconds.

In alternative embodiments, the A/D converter 414 can have multiplexing functionality or be coupled to a multiplexer such that the digitized x-axis signal and the digitized y-axis signal are multiplexed and then transmitted to the processor 310. Also, the x-axis switch 412 and the y-axis switch 413 can be combined into a single switch that alternates between directing the x-axis signal and the y-axis signal to different parts of the overall circuitry. Further, for a signal generated by an analog input device 120 that comprises both x-axis and y-axis signals, the processor 310 can poll both signals after either has crossed the predetermined threshold. Polling both the x-axis and y-axis signals ensures that values are in “matched pairs” (i.e., sampled at the same point and place in time, rather than sampled at different times). One ordinarily skilled in the art will recognize that other embodiments can include additional circuitry and functionality, such as additional signal processing, and still remain within the scope and spirit of this invention.

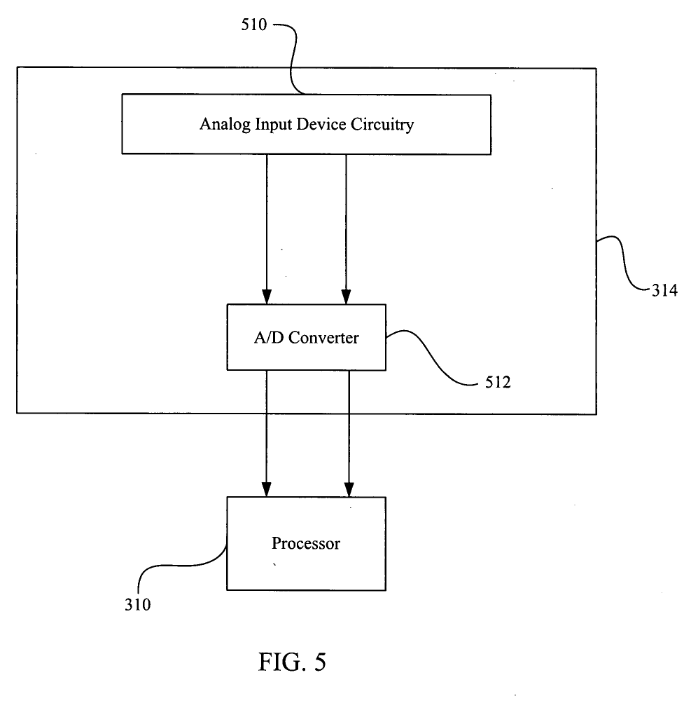

FIG. 5 is a block diagram illustrating an alternative embodiment of a system used to control the polling of a signal representing displacement information in the hand-held computing device 100. The system includes, but is not limited to, the analog input device subsystem 314 (FIG. 3) and the processor 310 (FIG. 3). As shown, the analog input device subsystem 314 includes analog input device circuitry 510 and an A/D converter 512.

The analog input device circuitry 510 is configured to transmit an x-axis signal and a y-axis signal to the A/D converter 512 when the user inputs information into the hand-held computing device 100 (FIG. 1) using the analog input device 120 (FIG. 1). In one embodiment, the analog input device circuitry 510 includes two potentiometers (not shown), in which a first potentiometer produces a first analog signal in response to a displacement of the analog input device 120 in the positive or negative x-direction (the x-axis signal), and a second potentiometer that produces an analog signal in response to a displacement of the analog input device 120 in the positive or negative y-direction (the y-axis signal). One skilled in the art will recognize that the analog input device circuitry 510 can include any type of components, electronic or otherwise, so long as the resulting circuit produces an analog signal in response to displacing the analog input device 120 from its x-axis or y-axis baseline or return positions.

The A/D converter 512 is configured to receive the analog x-axis signal, to convert the analog x-axis signal into a corresponding digitized x-axis signal, and to transmit the digitized x-axis signal to the processor 310. The processor 310 is configured to receive the digitized x-axis signal, and to poll that signal to determine whether it exceeds the predetermined x-axis threshold corresponding to a specific amount of displacement of the analog input device 120 in the x-direction. In one embodiment, the predetermined x-axis threshold corresponds to a displacement of 30-40% of the maximum possible displacement of the analog input device 120 in the x-direction. The processor 310 is configured such that, if the digitized x-axis signal does not exceed the predetermined x-axis threshold, the processor 310 polls the signal at a first specified frequency for purposes of computing the displacement of the analog input device 120 in the x-direction. In one embodiment, the first specified frequency is 10 Hertz. The processor 310 is further configured such that, if the digitized x-axis signal exceeds the predetermined x-axis threshold, the processor 310 polls the signal at a second specified frequency, which is higher than the first frequency, for purposes of computing the displacement of the analog input device 120 in the x-direction. In one embodiment, the second specified frequency is 100 Hertz.

In addition, the processor 310 is configured to detect when the analog input device 120 returns to its x-axis baseline or return position, and to measure how long the analog input device 120 remains in that position. Upon determining that the analog input device 120 has remained in its x-axis baseline or return position for a predetermined amount of time, the processor 310 returns to polling the digitized x-axis signal at the first specified frequency. In one embodiment, this predetermined amount of time is in the range of 5-10 seconds.

Similarly, the A/D converter 512 is configured to receive the analog y-axis signal, to convert the analog y-axis signal into corresponding digitized y-axis signal, and to transmit the digitized y-axis signal to the processor 310. The processor 310 is configured to receive the digitized y-axis signal, and to measure that signal to determine whether it exceeds the predetermined y-axis threshold corresponding to a specific amount of displacement of the analog input device 120 in the y-direction. In one embodiment, the predetermined y-axis threshold corresponds to a displacement of 30-40% of the maximum possible displacement of the analog input device 120 in the y-direction. The processor 310 is configured such that, if the digitized y-axis signal does not exceed the predetermined y-axis threshold, the processor 310 polls the signal at a first specified frequency for purposes of computing the displacement of the analog input device 120 in the y-direction. In one embodiment, the first specified frequency is 10 Hertz. The processor 310 is further configured such that, if the digitized y-axis signal exceeds the predetermined y-axis threshold, the processor 310 polls the signal at a second specified frequency, which is higher than the first frequency, for purposes of computing the displacement of the analog input device 120 in the y-direction. In one embodiment, the second specified frequency is 100 Hertz.

In addition, the processor 310 is configured to detect when the analog input device 120 returns to its y-axis baseline or return position, and to measure how long the analog input device 120 remains in that position. The processor 310 is further configured such that, upon determining that the analog input device 120 has remained in its y-axis baseline or return position for a predetermined amount of time, the processor 310 returns to polling the digitized y-axis signal at the first specified frequency. In one embodiment, this predetermined amount of time is in the range of 5-10 seconds.

In alternative embodiments, the A/D converter 512 can have multiplexing functionality or be coupled to a multiplexer such that the digitized x-axis signal and the digitized y-axis signal are multiplexed and then transmitted to the processor 310. Further, for a signal generated by an analog input device 120 that comprises both x-axis and y-axis signals, the processor 310 can poll both signals after either has crossed the predetermined threshold. Polling both the x-axis and y-axis signals ensures that values are in matched pairs. Also, one ordinarily skilled in the art will recognize that other embodiments can include additional circuitry and functionality, such as additional signal processing, and still remain within the scope and spirit of this invention.

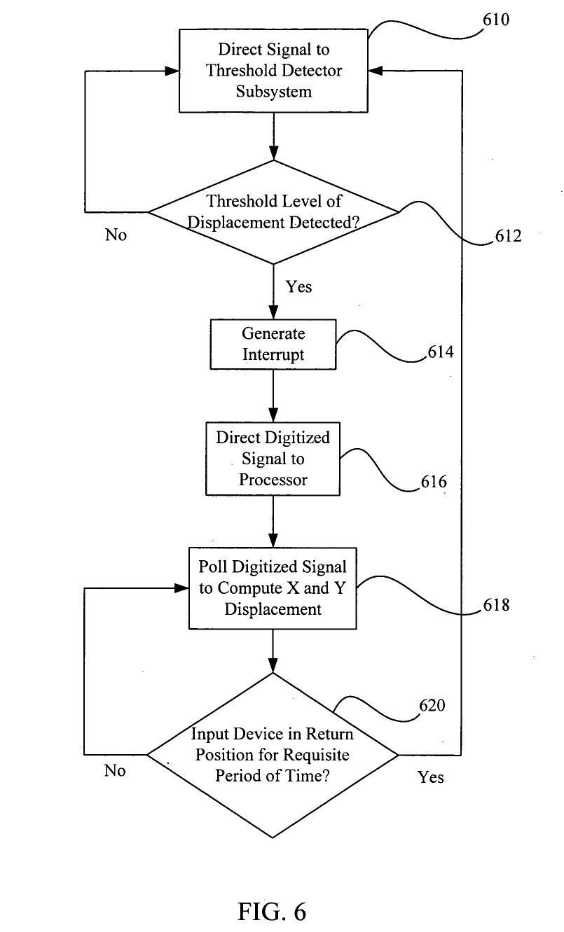

FIG. 6 shows a flowchart of method steps for controlling the polling of a signal representing displacement information in the hand-held computing device 100 (FIG. 1), according to one embodiment of the present invention. Although the method steps are described in the context of the systems illustrated in FIGS. 1-5, any system configured to perform the method steps is within the scope of the present invention.

As shown in FIG. 6 in a step 610, the x-axis switch 412 (FIG. 4) directs the x-axis signal transmitted from the analog input device circuitry 410 (FIG. 4) to the x-axis threshold detector circuitry 416 (FIG. 4). Also in step 610, the y-axis switch 413 (FIG. 4) directs the y-axis signal transmitted from the analog input device circuitry 410 to the y-axis threshold detector circuitry 417 (FIG. 4). The analog input device circuitry 410 produces the x-axis signal and the y-axis signal in response to displacement of the analog input device 120 (FIG. 1) in the x-direction and the y-direction, respectively.

In step 612, the x-axis threshold detector circuitry 416 determines whether the x-axis signal exceeds a predetermined x-axis threshold. Similarly, the y-axis threshold detector circuitry 417 determines whether the y-axis signal exceeds the predetermined y-axis threshold. If the x-axis threshold detector circuitry 416 determines that the x-axis signal does not exceed the predetermined x-axis threshold, the method returns to step 610, and the x-axis switch 412 continues to route the x-axis signal to the x-axis threshold detector circuitry 416. If, however, the x-axis threshold detector circuitry 416 determines that the x-axis signal exceeds the predetermined x-axis threshold, then in step 614, the x-axis threshold detector circuitry 416 transmits the interrupt 418 (FIG. 4) to the processor 310.

In step 616, upon receiving the interrupt 418, the processor 310 commands the x-axis switch 412 to route the x-axis signal to the processor 310 instead of the x-axis threshold detector circuitry 416. In routing the x-axis signal to the processor 310, the x-axis switch 412 transmits the x-axis signal to the A/D converter 414 (FIG. 4) where the x-axis signal is digitized and then transmitted to the processor 310. Next, in step 618, upon receiving the digitized signal, the processor 310 polls the signal at a specified frequency for purposes of computing the displacement of the analog input device 120 in the x-direction.

In step 620, the processor 310 determines whether the analog input device 120 has returned to its x-axis baseline or return position and remained in that position for a predetermined amount of time. If the analog input device 120 has not remained in its x-axis baseline or return position for the predetermined amount of time, the method returns to step 618 and the processor 310 continues to poll the digitized x-axis signal at the specified frequency. If the analog input device 120 has remained in its x-axis baseline or return position for the predetermined amount of time, the method returns to step 610, and the processor 310 commands the x-axis switch 412 to route the x-axis signal transmitted from the analog input device circuitry 410 to the x-axis threshold detector circuitry 416.

Similarly, in step 612, if the y-axis threshold detector circuitry 417 determines that the y-axis signal does not exceed the predetermined y-axis threshold, the method returns to step 610, and the y-axis switch 413 continues to route the y-axis signal to the y-axis threshold detector circuitry 417. If, however, the y-axis threshold detector circuitry 417 determines that the y-axis signal exceeds the predetermined y-axis threshold, then in step 614, the y-axis threshold detector circuitry 417 transmits the interrupt 419 to the processor 310.

In step 616, upon receiving the interrupt 419, the processor 310 commands the y-axis switch 413 to route the y-axis signal to the processor 310 instead of the y-axis threshold detector circuitry 417. In routing the y-axis signal to the processor 310, the y-axis switch 413 transmits the y-axis signal to the A/D converter 414 where the y-axis signal is digitized and then transmitted to the processor 310. Next, in step 618, upon receiving the digitized signal, the processor 310 polls the signal at a specified frequency for purposes of computing the displacement of the analog input device 120 in the y-direction.

In step 620, the processor 310 determines whether the analog input device 120 has returned to its y-axis baseline or return position and remained in that position for a predetermined amount of time. If the analog input device 120 has not remained in its y-axis baseline or return position for the predetermined amount of time, the method returns to step 618 and the processor 310 continues to poll the digitized y-axis signal at the specified frequency. If the analog input device 120 has remained in its y-axis baseline or return position for the predetermined amount of time, the method returns to step 610, and the processor 310 instructs the y-axis switch 413 to route the y-axis signal transmitted from the analog input device circuitry 410 to the y-axis threshold detector circuitry 417.

It should be noted that although the method steps of FIG. 6 describe the polling and subsequent processing of the x-axis and y-axis signals independently, the processor 310 can poll both signals after either has crossed the predetermined threshold. Polling both the x-axis and y-axis signals ensures that values are in matched pairs.

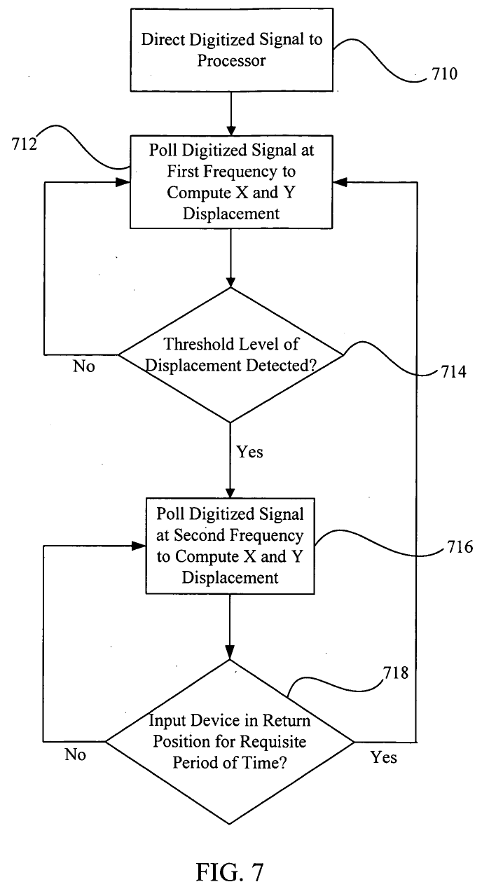

FIG. 7 shows a flowchart of method steps for controlling the polling of a signal representing displacement information of the analog input device 120 (FIG. 1) included in the hand-held computing device 100 (FIG. 1), according to another embodiment of the present invention. Although the method steps are described in the context of the systems illustrated in FIGS. 1-5, any system configured to perform the method steps is within the scope of the present invention.

As shown in FIG. 7, the analog input device circuitry 510 (FIG. 5) transmits an x-axis signal and a y-axis signal to the processor 310 (FIG. 3) in step 710. As described herein, the analog input device circuitry 510 produces the x-axis signal and the y-axis signal in response to a displacement of the analog input device 120 in either or both of the x-direction and the y-direction, respectively. In routing the x-axis signal and y-axis signal to the processor 310, the analog input device circuitry 510 transmits the signals to the A/D converter 512 (FIG. 5), where the signals are digitized and then transmitted to the processor 310. In step 712, upon receiving the digitized x-axis signal and digitized y-axis signal, the processor 310 polls the signals at a first specified frequency for purposes of computing the displacement of the analog input device 120 in the x-direction and the y-direction.

Next, in step 714, the processor 310 determines whether either the digitized x-axis signal exceeds the predetermined x-axis threshold or the digitized y-axis signal exceeds the predetermined y-axis threshold. If the processor 310 determines that the digitized x-axis signal does not exceed the predetermined x-axis threshold, the method returns to step 712, and the processor 310 continues to poll the digitized x-axis signal at the first specified frequency. If, however, the processor 310 determines that the digitized x-axis signal exceeds the predetermined x-axis threshold, then in step 716, the processor 310 polls the digitized x-axis signal at a second specified frequency, instead of the first specified frequency, for purposes of computing the displacement of the analog input device 120 in the x-direction. The second specified frequency is greater than the first specified frequency.

In step 718, the processor 310 determines whether the analog input device 120 has returned to its x-axis baseline or return position and remained in that position for a predetermined amount of time. If the analog input device 120 has not remained in its x-axis baseline or return position for the predetermined amount of time, the method returns to step 716, and the processor 310 continues to poll the digitized x-axis signal at the second specified frequency. If the analog input device 120 has remained in its x-axis baseline or return position for the predetermined amount of time, the method returns to step 712, and the processor 310 polls the digitized x-axis signal at the first specified frequency.

Similarly, if at step 714, the processor 310 determines that the digitized y-axis signal does not exceed the predetermined y-axis threshold, the method returns to step 712, and the processor 310 continues to poll the digitized y-axis signal at the first specified frequency. If, however, the processor 310 determines that the digitized y-axis signal exceeds the predetermined y-axis threshold, then in step 716, the processor 310 polls the digitized x-axis signal at a second specified frequency, instead of the first specified frequency, for purposes of computing the displacement of the analog input device 120 in the y-direction. The second specified frequency is greater than the first specified frequency.

In step 718, the processor 310 determines whether the analog input device 120 has returned to its y-axis baseline or return position and remained in that position for a predetermined amount of time. If the analog input device 120 has not remained in its y-axis baseline or return position for the predetermined amount of time, the method returns to step 716 and the processor 310 continues to poll the digitized y-axis signal at the second specified frequency. If the analog input device 120 has remained in its y-axis baseline or return position for the predetermined amount of time, the method returns to step 712, and the processor 310 polls the digitized y-axis signal at the first specified frequency.

It should be noted that although the method steps of FIG. 7 describe the polling and subsequent processing of the x-axis and y-axis signals independently, the processor 310 can poll both signals after either has crossed the predetermined threshold. Polling both the x-axis and y-axis signals ensures that values are in matched pairs.

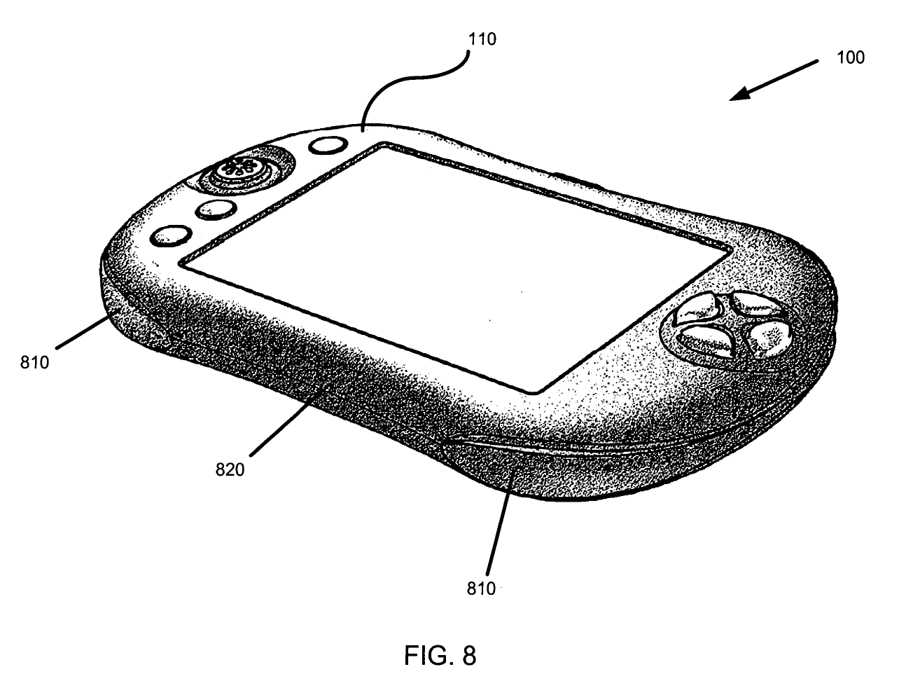

FIG. 8 is an isometric illustration of the hand-held computing device 100 of FIG. 1 showing a set of input devices 810 disposed at a mid-frame 820 of the housing 110, according to one embodiment of the present invention. As shown, the mid-frame 820 is disposed between the front and back faces of the housing 110. In one embodiment, the mid-frame 820 may be a separate piece of the housing 110 coupled to the front and back faces of the housing 110. In other embodiments, one part of the mid-frame 820 may be continuous with the front face of the housing 110, and the other part of the mid-frame 820 may be continuous with the back face of the housing 110. In yet other embodiments, the front face of the housing 110, the mid-frame 820 and the back face of the housing 110 may be one continuous piece. As shown, the input devices 810 are disposed at the mid-frame 820 near the upper corners of the hand-held device 100. In other embodiments, any number of input devices 810 may be disposed at any location on the mid-frame 820.

One advantage of the system and method described above is that the processor 310 polls the digitized x-axis signal and digitized y-axis signal at a high frequency only after the analog input device 120 has been moved sufficiently (i.e., when the displacement of the analog input device 120 produces a digitized x-axis signal or a digitized y-axis signal that exceeds the predetermined x-axis threshold or predetermined y-axis threshold, as the case may be). Otherwise, the processor 310 does not poll any signal associated with the analog input device 120 (in one embodiment of the present invention), or the processor 310 polls the relevant signal at a low frequency (in an alternative embodiment of the present invention). The result is that fewer processor resources are needed to process information generated by the analog input device 120, leaving more processor bandwidth for other processing functions. This increase in available processor resources, among other things, increases performance in the hand-held computing device 100. Further, the processor 310 uses less battery power as the processor 310 avoids having to poll signals produced by the analog input device 120 at high frequencies all the time.

The present invention has been described above with reference to specific embodiments. Those skilled in the art, however, will understand that various modifications and changes may be made thereto without departing from the broader spirit and scope of the present invention as set forth in the claims. For example, although the embodiments set forth above implement an analog device that generates signals representative of displacement in two orthogonal directions (i.e., x-axis and y-axis signals), the system and method of the present invention may also implement analog devices that generate signals representative of displacement in a lesser or greater number of dimensions. The foregoing description and drawings therefore should be regarded in an illustrative rather than a restrictive sense.

What is claimed is:

1. A system for selectively controlling polling of a signal representing displacement information in a hand-held computing device, comprising:
an analog input device system configured to generate the signal;
a threshold detector system configured to receive the signal and to generate an interrupt if the signal exceeds a predetermined threshold; and
a switch having at least a first and a second state, the switch configured to direct the signal to the threshold detector system when in the first state and to a processor when in the second state.

2. The system of claim 1, wherein the switch is further configured to switch from the first to the second state in response to the generation of the interrupt.

3. The system of claim 1, further comprising an analog-to-digital converter configured to receive the signal directed by the switch when the switch is in the second state, the analog-to-digital converter further configured to digitize the signal and to direct the digitized signal to the processor.

4. The system of claim 1, wherein the predetermined threshold corresponds to a displacement of 30-40% of a maximum possible displacement of an analog input device, the analog input device being coupled to the analog input device circuitry such that the analog input device circuitry generates the signal when the analog input device is displaced.

5. The system of claim 1, wherein the processor is configured to poll the digitized signal at a specified frequency for purposes of computing displacement information when the switch is in the second state.

6. The system of claim 5, wherein the specified frequency is 100 Hertz.

7. The system of claim 5, wherein the processor is further configured to determine, while polling the digitized signal, whether the digitized signal has indicated zero displacement for a predetermined amount of time, and configured to cause the switch to return to the first state upon making such a determination.

8. The system of claim 7, wherein the predetermined amount of time is 5-10 seconds.

9. A system for selectively controlling polling of signals representing displacement information in a hand-held computing device, comprising:
an analog input device system configured to generate a first signal representative of displacement in a first dimension and a second signal representative of displacement in a second dimension;
a threshold detector system configured to receive the first and second signals and to generate a first interrupt if the first signal exceeds a first predetermined threshold or a second interrupt if the second signal exceeds a second predetermined threshold;
a first switch having at least a first and a second state, the first switch configured to direct the first signal to the threshold detector system when in the first state and to a processor when in the second state; and
a second switch having at least a first and a second state, the second switch configured to direct the second signal to the threshold detector system when in the first state and to the processor when in the second state.

10. The system of claim 9, wherein the first switch is further configured to switch from the first to the second state in response to the generation of the first interrupt.

11. The system of claim 9, wherein the second switch is further configured to switch from the first to the second state in response to the generation of the second interrupt.

12. A system for selectively controlling polling of a signal representing displacement information in a hand-held computing device, comprising:
an analog input device system configured to generate the signal; and
a processor configured to receive a digitized signal corresponding to the signal and to determine whether the digitized signal exceeds a predetermined threshold, the processor further configured to poll the digitized signal at a first frequency if the digitized signal does not exceed the predetermined threshold and to poll the digitized signal at a second frequency if the digitized signal exceeds the predetermined threshold, the second frequency being greater than the first frequency.

13. The system of claim 12, wherein the predetermined threshold corresponds to a displacement of 30-40% of a maximum possible displacement of an analog input device, the analog input device being coupled to the analog input device system such that the analog input device system generates the signal when the analog input device is displaced.

14. The system of claim 12, wherein the first frequency is 10 Hertz and the second frequency is 100 Hertz.

15. The system of claim 12, further comprising an analog-to-digital converter configured to receive the signal generated by the analog input device system, to digitize the signal, and to direct the digitized signal to the processor.

16. The system of claim 12, wherein the processor is further configured to determine, while polling the digitized signal at the second frequency, whether the digitized signal has indicated zero displacement for a predetermined amount of time, and configured to return to polling the digitized signal at the first frequency upon making such a determination.

17. The system of claim 16, wherein the predetermined amount of time is 5-10 seconds.

18. A method for selectively controlling polling of a signal representing displacement information in a hand-held computing device, comprising:
directing the signal to a threshold detector system;
determining whether the signal exceeds a predetermined threshold;
generating an interrupt if the signal exceeds the predetermined threshold; and
polling the digitized signal at a specified frequency for purposes of computing displacement information.

19. The method of claim 18, further comprising directing a digitized signal corresponding to the signal to a processor in response to the generation of the interrupt.

20. The method of claim 18, further comprising determining, while polling the digitized signal, whether the digitized signal has indicated zero displacement for a predetermined amount of time, and directing the signal back to the threshold detector system upon making such a determination.

21. The method of claim 20, wherein the predetermined amount of time is 5-10 seconds.

22. The method of claim 18, wherein the predetermined threshold corresponds to a displacement of 30-40% of a maximum possible displacement of an analog input device, the analog input device being coupled to an analog input device system such that the analog input device system generates the signal when the analog input device is displaced.

23. The method of claim 18, wherein the specified frequency is 100 Hertz.

24. A method for selectively controlling polling of a signal representing displacement information in a hand-held computing device, comprising:
directing a digitized signal corresponding to the signal to a processor;
polling the digitized signal at a first frequency for purposes of computing displacement information;
determining whether the digitized signal exceeds a predetermined threshold; and
polling the digitized signal at a second frequency if the digitized signal exceeds the predetermined threshold.

25. The method of claim 24, further comprising determining, while polling the digitized signal at the second frequency, whether the digitized signal has indicated zero displacement for a predetermined amount of time, and returning to polling the digitized signal at the first frequency upon making such a determination.

26. The method of claim 25, wherein the predetermined amount of time is 5-10 seconds.

27. The method of claim 24, wherein the predetermined threshold corresponds to a displacement of 30-40% of a maximum possible displacement of an analog input device, the analog input device being coupled to an analog input device system such that the analog input device system generates the signal when the analog input device is displaced.

28. The method of claim 24, wherein the first frequency is 10 Hertz and the second frequency is 100 Hertz.

29. A computer readable medium having embodied thereon a program, the program being executable by a machine to perform a method for selectively controlling the polling of a signal representing displacement information in a hand-held computing device, the method comprising:
directing the signal to a threshold detector system;
determining whether the signal exceeds a predetermined threshold;
generating an interrupt if the signal exceeds the predetermined threshold; and
polling the digitized signal at a specified frequency for purposes of computing displacement information.

30. The computer readable medium of claim 29, wherein the method further comprises directing a digitized signal corresponding to the signal to a processor in response to the generation of the interrupt.

31. A system for selectively controlling the polling of a signal representing displacement information in a hand-held computing device, comprising:
means for directing a digitized signal corresponding to the signal to a processor;
means for polling the digitized signal at a first frequency for purposes of computing displacement information;
means for determining whether the digitized signal exceeds a predetermined threshold; and
means for polling the digitized signal at a second frequency if the digitized signal exceeds the predetermined threshold.

32. The system of claim 31, further comprising means for determining, while polling the digitized signal at the second frequency, whether the digitized signal has indicated zero displacement for a predetermined amount of time and returning to polling the digitized signal at the first frequency upon making such a determination.

33. The system of claim 32, wherein the predetermined amount of time is 5-10 seconds.

34. The system of claim 31, wherein the predetermined threshold corresponds to a displacement of 30-40% of the maximum possible displacement of an analog input device, the analog input device being coupled to an analog input device system such that the analog input device system generates the signal when the analog input device is displaced.

35. The system of claim 30, wherein the first frequency is 10 Hertz and the second frequency is 100 Hertz.
